(19) United States
(12) Patent Application Publication
(10) Pub. No.: US 2010/0023457 A1
(43) Pub. Date: Jan. 28, 2010

(54) Methods and systems for tracking commodity performance

(75) Inventors: Tarik Riviere, New York, NY (US); Roy P. Adams, Bronx, NY (US); Michael D. Waldron, New York, NY (US)

Correspondence Address: LEHMAN BROTHERS INC.;C/O MORGAN, LEWIS & BOCKIUS, LLP, 1111 PENNSYLVANIA AVE. N.W., WASHINGTON, DC, 20004, US

(73) Assignee: Barclays Capital Inc., New York, NY (US)

(21) Appl. No.: 12/291,436

(22) Filed: Nov. 10, 2008

Related U.S. Application Data
(60) Provisional application No. 60/986,634, filed on Nov. 9, 2007.

(51) Int. Cl. G06Q 40/00

(52) U.S. Cl. 705/36 R

(57) ABSTRACT

In at least one aspect, the invention comprises a computer-implemented method comprising: (a) electronically receiving data regarding projections of commodity consumption for exchange-traded futures contracts on one or more biofuel feedstock commodities; (b) selecting, based on said received data, one or more of said futures contracts for inclusion in a biofuel excess return strategy index; and (c) electronically weighting each of said selected one or more futures contracts; wherein said weighting is based on projected relative consumption of each commodity corresponding to said selected futures contracts. In another aspect, the invention comprises a computer-implemented method comprising: (a) electronically receiving data regarding prices of one or more exchange-traded futures contracts; (b) selecting, based on said received data, one or more of said futures contracts for inclusion in a commodity index; and (c) electronically calculating excess return for each of said commodities by accounting for foreign exchange rates.

### CROSS-REFERENCE TO RELATED APPLICATIONS

This application claims priority to U.S. Provisional Application No. 60/986,634, filed Nov. 9, 2007. The entire contents of that provisional application are incorporated herein by reference.

### INTRODUCTION

Biofuels are fuels derived from biomass and are considered a renewable energy source. Biofuels have much lower emissions than traditional fuels of almost every pollutant: carbon dioxide, sulfur oxide, air toxins, etc. Agricultural products specifically grown for the use of biofuels include corn, soybeans, flaxseed, rapeseed, sugar cane, palm oil, and jatropha.

Ethanol is the best known and most common biofuel. Up to 10% of ethanol can be mixed with conventional gasoline to be used in regular engines without any modification. However, to use ethanol in higher percentages, engines would need significant modifications.

Biodiesel is a biofuel that can be mixed with conventional diesel in any percentage and doesn't require any modification to diesel engines. Table 1 compares certain properties of ethanol and biodiesel.

TABLE 1

| Ethanol | | Biodiesel |
|---|---|---|
| Demographics | Most popular in US and Brazil | Most popular in Europe |
| Description | Starch-based gasoline blending | Vegetable oil- or animal- |
| | agent with ⅔ energy content | based diesel blending |
| | of conventional gasoline | agent with 90% energy |
| | | content of conventional |
| | | diesel |
| Production | 900k b/d (barrels per day) | 170k b/d |
| (2007E) | | |
| Components | Corn, sugar, beets, sugar cane | Rapeseed, soybeans, |
| | | palm oil, animal fats |

Ethanol production is expected to grow by over 15% per year from 2006-2010. See FIG. 1. The United States and Brazil are expected to account for 75% of ethanol, with China likely to also be a significant producer. But biodiesel is considered by many to be a better alternative to ethanol. Biodiesel production is growing at a faster rate than ethanol production, albeit from a smaller base. Government incentives for ultra-low sulfur diesel have spurred production. 2006 global production is estimated to have been 115K barrels per day (“b/d”), with expected growth to 350K b/d by 2010. See FIG. 2. The EU has enacted a 2020 target of mandatory 10% transport fuels from biofuels.

While biofuel numbers will likely remain relatively small, they are growing large enough to affect global supplies and refinery margins, and biofuels could meet a third of incremental transportation fuel demand by 2010.

Biodiesel production for the EU derives in large part from rapeseed, while that of the US and Asia comes primarily from soybeans and palm oil, respectively. Rapeseed is a bright yellow plant that is the primary ingredient in EU biodiesel, which is typically blended with plain diesel to extend fuel life. Soybean oil is used to create biodiesel in the U.S., along with corn. Palm oil is the world's most popular source for vegetable oil. The Malaysian government has subsidized production to meet burgeoning EU demand.

Biodiesel possesses more than 90% of the energy content of conventional diesel. Biodiesel is usually blended with diesel to form B5 (5% biodiesel, 95% diesel) and B20, which can be used with no changes to service stations.

An embodiment of the present invention utilizes a biodiesel strategy to provide investors with exposure to biodiesel. The biodiesel strategy index (also referred to herein as “strategy” or “index”) tracks the performance of a basket of global commodity futures contracts linked to the consumption of biodiesel feedstock. The strategy applies a dynamic weight-adjustment methodology and allocates among commodity futures based on annual biodiesel consumption estimates. See FIGS. 2, 3, and 4.

The commodities eligible for the strategy are commodities that are processed by the global biodiesel industry. In an embodiment, the top three commodities by consumption are selected.

The commodity futures contracts based on the eligible commodities are selected, in an embodiment, to meet minimum liquidity criteria, such as trading on a futures exchange and having no regulatory or other extraneous factors impeding the free trading of the contracts.

In an embodiment, for each of the three eligible commodities, the weight is calculated annually as the ratio of that commodity's consumption divided by total consumption for the three eligible commodities. The highest weight (in this embodiment) is capped at 45%, with any unallocated weight applied to the remaining two commodities, where the smallest one is floored at 20%. This weighting methodology achieves a range floating allocation where the individual weights are range bound between 20% and 45%. Those skilled in the art will recognize that these percentages are exemplary only, and that other percentages may be used within the above framework without departing from the scope of the present invention. The daily performance is calculated based on the annually determined weights and the daily price performance of the futures.

In at least one aspect of the invention, foreign exchange (“FX”) risk of underlying commodities is directly factored into the index rather than having to be externally manipulated. This makes it easier for investors to determine the return of the index in their domestic currency.

At least one aspect of the invention uses forecasts rather than past price data. Relying on future predictions ensures that the strategy is in better sync with the current industry utilization rather than relying on stale historic returns data.

Rules used by one or more embodiments to select the commodities and their weights allocate weights based on the volumetric contribution of each commodity to overall biodiesel consumption.

In one aspect, the invention comprises a computer-implemented method comprising: (a) electronically receiving data regarding projections of commodity consumption for exchange-traded futures contracts on one or more biofuel feedstock commodities; (b) selecting, based on said received data, one or more of said futures contracts for inclusion in a biofuel excess return strategy index; and (c) electronically weighting each of said selected one or more futures contracts; wherein said weighting is based on projected relative consumption of each commodity corresponding to said selected futures contracts.

In various embodiments: (1) said projected relative consumption is based on one or more projections for consumption of each commodity over a future period of time; (2) at least one of said projections is made by a non-trading desk entity; (3) no commodity is weighted more than a specified maximum weight; (4) no commodity is weighted less than a specified minimum weight; and (5) said biofuel is biodiesel.

In another aspect, the invention comprises a computer-implemented method comprising: (a) electronically receiving data regarding prices of one or more exchange-traded futures contracts; (b) selecting, based on said received data, one or more of said futures contracts for inclusion in a commodity index; and (c) electronically calculating excess return for each of said commodities by accounting for foreign exchange rates.

In various embodiments: (1) excess return of a commodity comprises daily price appreciation of associated futures contracts of said commodity plus roll yield; (2) daily excess return of a commodity is calculated based on a first product comprising a commodity futures contract price for a first day multiplied by a difference between a spot currency exchange rate for said first day and a spot next currency swap rate for a day immediately preceding said first day; (3) daily excess return of a commodity is calculated further based on dividing said first product by a second product comprising a commodity futures contract price for said day immediately preceding said first day multiplied by a spot currency exchange rate for said day immediately preceding said first day; (4) daily excess return is based on a product of a commodity futures contract price and a foreign exchange rate, and wherein said foreign exchange rate is corrected for overnight drift; (5) foreign exchange spot rates are used in calculation of excess return, and said calculation is adjusted to take into account an overnight funding differential between two currencies; (6) said differential is calculated on a weekly basis; and (7) the method further comprises receiving one or more valuations for spot week forward transactions and calculating a daily differential for a subsequent week.

In another aspect, the invention comprises a computer system comprising: (a) a database component configured to electronically receive and store data regarding projections of commodity consumption for exchange-traded futures contracts on one or more biofuel feedstock commodities; (b) a selection component configured to select, based on said received and stored data, one or more of said futures contracts for inclusion in a biofuel excess return strategy index; and (c) a weighting component configured to electronically weight each of said selected one or more futures contracts; wherein said weight is based on projected relative consumption of each commodity corresponding to said selected futures contracts.

In various embodiments: (1) said projected relative consumption is based on one or more projections for consumption of each commodity over a future period of time; (2) at least one of said projections is made by a non-trading desk entity; (3) no commodity is weighted more than a specified maximum weight; (4) no commodity is weighted less than a specified minimum weight; and (5) said biofuel is biodiesel.

In another aspect, the invention comprises a computer system comprising: (a) a database component configured to electronically receive and store data regarding prices of one or more exchange-traded futures contracts; (b) a selection component configured to select, based on said received and stored data, one or more of said futures contracts for inclusion in a commodity index; and (c) a calculation component configured to electronically calculate excess return for each of said commodities by accounting for foreign exchange rates.

In various embodiments: (1) excess return of a commodity comprises daily price appreciation of associated futures contracts of said commodity plus roll yield; (2) daily excess return of a commodity is calculated based on a first product comprising a commodity futures contract price for a first day multiplied by a difference between a spot currency exchange rate for said first day and a spot next currency swap rate for a day immediately preceding said first day; (3) daily excess return of a commodity is calculated further based on dividing said first product by a second product comprising a commodity futures contract price for said day immediately preceding said first day multiplied by a spot currency exchange rate for said day immediately preceding said first day; (4) daily excess return is based on a product of a commodity futures contract price and a foreign exchange rate, and wherein said foreign exchange rate is corrected for overnight drift; (5) foreign exchange spot rates are used in calculation of excess return, and said calculation is adjusted to take into account an overnight funding differential between two currencies; (6) said differential is calculated on a weekly basis; and (7) the system further comprises a valuation component configured to receive one or more valuations for spot week forward transactions and calculating a daily differential for a subsequent week.

In another aspect, the invention comprises software stored in a computer readable medium, said software comprising: (a) software for electronically receiving data regarding projections of commodity consumption for exchange-traded futures contracts on one or more biofuel feedstock commodities; (b) software for selecting, based on said received data, one or more of said futures contracts for inclusion in a biofuel excess return strategy index; and (c) software for electronically weighting each of said selected one or more futures contracts; wherein said weighting is based on projected relative consumption of each commodity corresponding to said selected futures contracts.

In various embodiments: (1) said projected relative consumption is based on one or more projections for consumption of each commodity over a future period of time; (2) at least one of said projections is made by a non-trading desk entity; (3) no commodity is weighted more than a specified maximum weight; (4) no commodity is weighted less than a specified minimum weight; and (5) said biofuel is biodiesel.

In another aspect, the invention comprises software stored in a computer readable medium, said software comprising: (a) software for electronically receiving data regarding prices of one or more exchange-traded futures contracts; (b) software for selecting, based on said received data, one or more of said futures contracts for inclusion in a commodity index; and (c) software for electronically calculating excess return for each of said commodities by accounting for foreign exchange rates.

In various embodiments: (1) excess return of a commodity comprises daily price appreciation of associated futures contracts of said commodity plus roll yield; (2) daily excess return of a commodity is calculated based on a first product comprising a commodity futures contract price for a first day multiplied by a difference between a spot currency exchange rate for said first day and a spot next currency swap rate for a day immediately preceding said first day; (3) daily excess return of a commodity is calculated further based on dividing said first product by a second product comprising a commodity futures contract price for said day immediately preceding said first day multiplied by a spot currency exchange rate for said day immediately preceding said first day; (4) daily excess return is based on a product of a commodity futures contract price and a foreign exchange rate, and wherein said foreign exchange rate is corrected for overnight drift; (5) foreign exchange spot rates are used in calculation of excess return, and said calculation is adjusted to take into account an overnight funding differential between two currencies; (6) said differential is calculated on a weekly basis; and (7) the software further comprises software for receiving one or more valuations for spot week forward transactions and calculating a daily differential for a subsequent week.

### BRIEF DESCRIPTION OF THE DRAWINGS

FIG. 1 depicts a world ethanol production forecast.

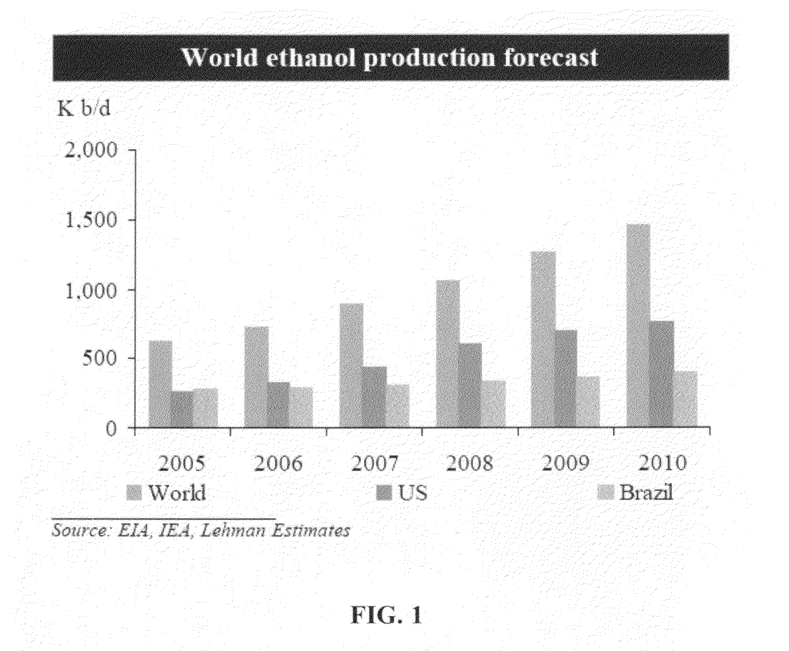

FIG. 2 depicts a world biodiesel production forecast.

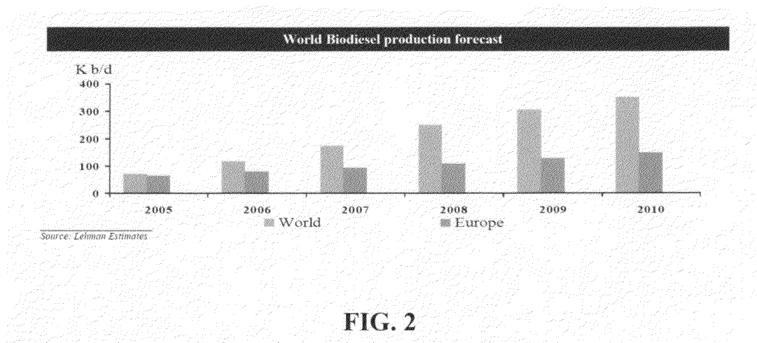

FIG. 3 depicts an exemplary biodiesel feedstock market composition.

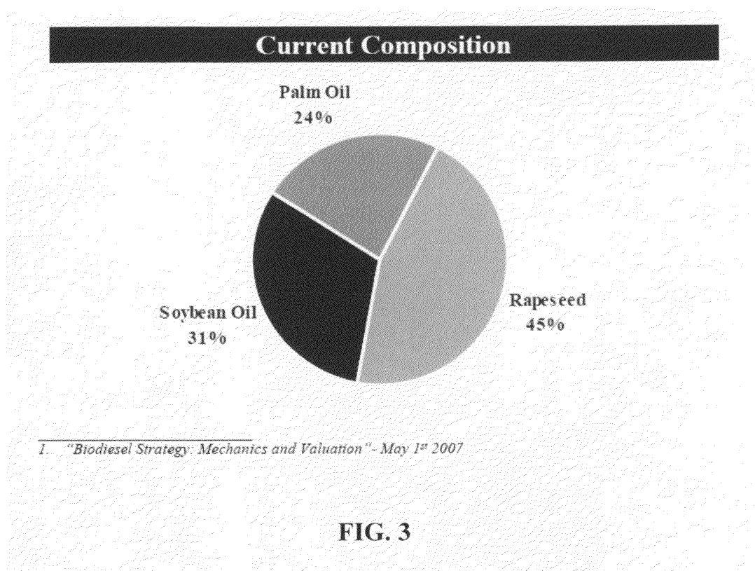

FIG. 4 illustrates performance of an embodiment.

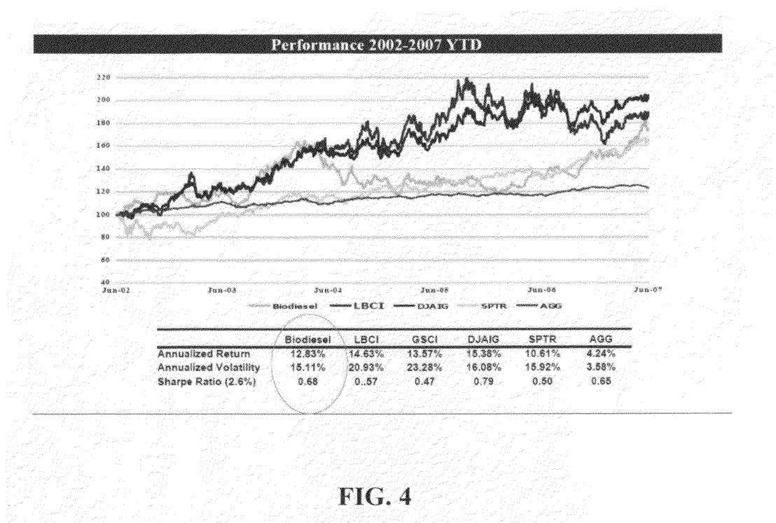

FIG. 5 depicts a computer based system for processing data according to an embodiment of the invention.

### DETAILED DESCRIPTION OF EXEMPLARY EMBODIMENTS

The commodities eligible for the strategy index are those identified as being currently processed by the global biodiesel industry, as per reports (typically annual) on the biofuels sector.

As will be familiar to those skilled in the art, a plot of the prices of all of the futures contracts for a commodity against maturity defines the futures curve. The first point in this curve is called the first nearby, or prompt contract, and is the closest thing in the commodities market to a spot price. The second point, representing the second month, is called the second nearby, or prompt+1.

Futures contracts selected for a strategy used in an embodiment preferably satisfy the following criteria: (1) underlying commodity is an eligible commodity; (2) contract is listed on a futures exchange; (3) contract rolling 3-month dollar volume meets a minimum phase-in liquidity threshold (e.g., $900 million), and where contracts do not trade on a U.S. exchange, the dollar value is derived using exchange rates; (4) in the case of multiple eligible contracts on the same commodity, the contract with the highest 3-month total dollar volume is selected, regardless of geographic consideration; (5) there are no regulatory or other extraneous factors impeding the free trading of the contract; (6) in cases where only one futures contract is eligible, the strategy is discontinued; and (7) in cases where an underlying commodity and one of its derivatives satisfies the eligibility criteria and futures satisfying all eligible criteria above exist for both, only the contract linked to the derivative will be eligible. For example, in the case of Soy Bean and Soy Bean Oil, only the Soy Bean Oil future is eligible.

Weighting Allocation

In an embodiment, for each eligible commodity, the forecast, rather than the previous year's actual contribution to overall biodiesel industry feedstock consumption is directly extracted from one or more (typically annual) research reports.

In exemplary embodiments, the weighting applied to each commodity is determined as follows:

1. The volumetric share of overall biodiesel consumption (“Related Consumption”) is extracted from one or more biofuels reports for each eligible futures contract.

2. The three contracts with the highest Related Consumption values are selected. The sum of these three Related Consumption numbers is calculated, resulting in an “Aggregate Consumption” value.

3. The commodity with the highest Related Consumption is considered first. Its weighting is calculated as the ratio of the Related Consumption over the Aggregate Consumption. If the weight is greater than 45%, its weight is capped at 45%. The Unallocated Weight is calculated as 100% minus this first calculated weight.

4. The Aggregate Consumption is now re-calculated using the two remaining commodities. The commodity with the lowest Related Consumption is considered next. Its weighting is calculated as the ratio of the Related Consumption over the new Aggregate Consumption, multiplied by the Unallocated Weight. If this weight is less than 20%, it will be floored at 20%.

5. The remaining contract weight can now be calculated as 100% minus the sum of the weights of the first two contract weights.

6. In the case where only two commodities are in the strategy, the weights are 68% and 32% applied to the commodities with the highest and lowest consumption levels, respectively.

Return Calculations

In an exemplary embodiment, strategy returns are calculated by weighting the commodity level returns by their contribution to the strategy. The following section shows how these returns may be calculated, and how they may aggregated to give a biodiesel strategy return.

Excess Return

As is known in the art, backwardation is a market condition in which a futures price is lower in the distant delivery months than in the near delivery months. Contango is the opposite situation. When the market is in backwardation, a futures index that rolls from the current contract to the next month's contract will realize a benefit. When the market is in contango, this results in a loss. This return is called the “roll yield.”

In an embodiment, commodity level excess returns represent the daily price appreciation of the underlying futures contracts plus roll yield. These returns reflect the spot and roll return of the prompt contract or a combination of the prompt and prompt+1 contracts. Also factored into returns calculations is the fact that commodity returns have to reflect the dynamics of underlying FX spot hedging for futures denominated in foreign currencies. Each business day's FX spot positions can be rolled to the next day at a market-defined level commonly referred to as “Spot Next.”

Daily Excess Return

The formula for daily excess return on a strategy commodity is as follows:

$${CER}_{t} = ( \frac{{F}_{t} \times [ {S}_{t} - {SN}_{t - 1} ]}{{F}_{t - 1 ( After Roll )} \times {S}_{t - 1}} ) - 1$$

Where.

CER: Commodity Excess Return;

Fₜ: Commodity Future Price on strategy business day t;

F_{t-1 After Roll)}: Commodity Future Price on strategy business day_{t-1 After Roll)};

S: Spot FX; and

SN: Estimated Spot Next FX Swap with USD as Quote Currency.

In an embodiment, Valid FX Spot Week data is accessed from electronic sources every Monday and applied to the strategy calculation from Tuesday onwards. Estimated FX SN is then calculated as FX Spot Week divided by 7 every day up to and including the following Monday. If Monday is not a valid business day or Spot Week is not available, Spot Next will reference the latest available posting on the relevant SOURCE PAGE until a valid Spot Week is available.

During the roll period, Fₜ and Fₜ₋₁ will be a composite price of the prompt contract and the prompt+1 contract weighted by the percentage that has been rolled at the end of the previous strategy business day. Because the contract roll begins at the end of the fifth business day, composite prices are used on the sixth through ninth days' return calculations.

For example, for soybean oil and rapeseed, on the sixth business day of the month: Fₜ=(80%*Fₜ Prompt)+(20%*Fₜ Prompt+1); and F_{t-1 (After Roll)}=(80%*Fₜ₋₁ Prompt)+(20%*Fₜ₋₁ Prompt+1).

Spot Return

Commodity level spot returns represent the daily price appreciation of the underlying futures contracts used to price the strategy before any contract rolling has occurred. They reflect the return of the current day's prompt contract or a combination of the prompt and prompt+1 contracts compared to the previous day's closing price before that day's roll has occurred.

Daily Spot Return

The formula for daily spot return on a strategy commodity is as follows:

$${CSR}_{t} = ( \frac{{F}_{t} \times St}{{F}_{t - 1 ( Before Roll )} \times {S}_{t - 1}} ) - 1$$

Where:

CSR: Commodity Spot Return;

Fₜ: Commodity Future Price on strategy business day t;

F_{t-1 (Before Roll)}: Commodity Future Price on strategy business day t−1 (Before Roll); and

S: Spot FX.

During the roll period, Fₜ will be a composite price of the prompt contract and the prompt+1 contract weighted by the percentage that has been rolled at the end of the previous strategy business day, while F_{t-1 (Before Roll)} will be a composite of closing prices before the roll has occurred for that day. Using soybean oil as an example, it will be recognized that the contract roll begins at the end of the fifth business day, and composite prices are used for Fₜ on the sixth through ninth days' return calculations and the seventh through tenth days' return calculations for F_{t-1 (Before Roll)}.

Strategy Currency Conversions Used in an Exemplary Embodiment

All European and American currencies in an embodiment are converted using cross rates from WM Reuters which are captured at 4:00 pm GMT.

All Asian currencies in an embodiment are converted using cross rates from the ABSG delivered via Reuters.

With regard to Non Deliverable Currencies, NDF Fixing is used in an embodiment.

Aggregating Commodity Returns into the Biodiesel Strategy Return

In an embodiment, two components used to calculate a commodity's daily weight in a strategy are the liquidity factor and the price. While a commodity's price changes daily based on movements in the futures markets, its liquidity factor or “amount outstanding” is reset only once a year based on the biodiesel consumption figures

Biodiesel Strategy Liquidity Factors

In order to ensure that the strategy commodity weights remain intact for the whole year, a constant is used known as the Liquidity Factor (LF). A separate LF is derived once per year for each commodity within the strategy. Each day the commodity specific LF is multiplied by the price of the futures contract and the product summed for each commodity. The daily changes in weights of each commodity within the strategy are thus a function only of price change. LF is defined as follows: Liquidity Factor=Percent Allocated to Commodity on the Last business Day in April/Price 2nd Business Day May, where Percent Allocated to Commodity Last business Day in April=Strategy allocation; and Price 2nd Business Day=Prompt contract closing price of commodity, as of the second business day of May*Spot FX.

Calculation of Daily Strategy Constituent Weights

Daily strategy weights are calculated by multiplying the liquidity factor of each commodity by its daily strategy price (beginning of day). After summing up this value for all commodities, each component's percentage contribution to the total is calculated. This percentage is the commodity weight used for daily strategy return calculations.

W_{b,i}=LFᵢ*P_{b,i}/Σ(LF*P_{b}) Biodiesel, where:

W_{b,i}=the beginning of day weight for Commodity I;

LFᵢ=the liquidity factor for Commodity I;

P_{b,i}=Future Price*Spot FX; and

Σ(LF*Pb) Biodiesel=Sum of (LF*P_{b}) for each Biodiesel Component.

Calculating Strategy Returns

Strategy level returns are generated by weighting the commodity level returns (spot or excess) of each constituent by its calculated beginning-of-day weight. These daily returns are then compounded to generate cumulative returns over periods longer than one day. (1) Daily Return Contribution Strategy Component=W_{b,i}*Returnₜ, where:

W_{b,i}=the beginning of day weight for Commodityᵢ; and

Returnₜ=the daily total/excess return of Commodityᵢ.

(2) Daily Strategy Excess/Spot Return=Σ Return Contribution Biodiesel strategy, where Return Contribution Biodiesel strategy=the excess/spot return contribution of each component.

Since Inception Strategy Returns

In an exemplary embodiment, daily strategy returns (excess and spot) are indexed to 100 as of the strategy inception date (e.g., Jun. 30, 2006). These daily returns are compounded to generate a daily strategy level for the biodiesel strategy and each of its components and can be used to calculate periodic returns over any user-defined date range using the following formula:

Periodic Return=(Biodiesel strategy Valueₜ/Biodiesel strategy Valueₜ₋₁)−1.

Business Day Calendar

The biodiesel strategy business day calendar of an embodiment follows the New York Mercantile Exchange (NYMEX) holiday calendar and is published only when the NYMEX is open for trading, including half-days.

On those days when relevant markets are closed and the NYMEX is open, use data from the previous available business day for strategy calculations.

On days when the NYMEX is closed and the other exchanges are open, returns will be reflected on the next day when the NYMEX is open.

Contract roll schedules will reflect the NYMEX calendar for all the commodities. If there is an NYMEX holiday before or during a roll period, the scheduled roll will be pushed forward to the next business day.

Initial strategy returns will be published between 4 pm and 6 pm EST on each biodiesel strategy business day. When final closing prices are published for each strategy contract on their respective exchanges, the daily returns will be finalized. Occasionally an exchange may update a final closing price after its initial publication. In those cases, returns will be updated with the new price when published.

If the price expected from an exchange is determined to be in error or is unavailable before the strategy is required to be published, the Strategy Agent reserves the right to provide a price for the strategy. However, if the exchange in question provides an appropriate value before trading opens on the following day, the Strategy Agent will restate returns.

Strategy Rebalancing Mechanism

New biodiesel commodity weights are determined on the 2nd business day of May. Rebalancing takes place during the 5th to 15th business days in May when 10% of the old Liquidity Factors is rolled out and 10% of the new is rolled in on each business day.

Market Disruption Events

In one or more embodiments, a number of market circumstances can lead to an adjustment in the rolling process. These adjustments occur when it would be difficult to liquidate or establish positions in the market and perform the roll. If any of these market disruption events occurs on any of the days during the roll period, the proportion of the roll that would have taken place on that day is skipped. For example, if a market disruption event occurs on the first day of the roll, none of the 80/20 roll is taken. Instead, the 60/40 proportion is taken on the next business day. If a market disruption event occurs on that day also, the roll proportion will be 40/60 on the following business day. Two examples of disruption events are:

Commodity reaches a limit price during the last 15 minutes of the trading session. If the prompt contract reaches a limit price during the final 15 minutes of regular or rescheduled trading, the roll will be skipped that day.

Trading interrupted or terminated on an exchange. If trading is terminated prior to the expected close of business and does not resume at least 15 minutes prior to the scheduled close, the roll will be deferred.

Changes in Futures Contract Liquidity

At the end of each month, the 3-month total dollar volume is observed for each futures contract within the strategy. If the observation for any component falls below the Minimum Phase-Out Threshold (e.g., $700 million), the strategy will phase out this component during the next scheduled roll period for the specific commodity. In the case where another contract coincidentally qualifies for inclusion, it will be added to the strategy following the roll period and schedule of the specific commodity. At launch an embodiment of the strategy may use a minimum Phase-In Threshold (e.g., of $900 million) and a minimum Phase-Out Threshold (e.g., of $700 million).

Consumption Data Disruption Events

New consumption data may made available by the close of business on the second business day of May. In the event that no data is available, the prior year's weightings may be retained. In an embodiment, more current consumption data may be used should it become available within a commercially reasonable time frame.

Roll Mechanics and Contract Calendar

Because the underlying constituents of the biodiesel strategy are futures contracts, they have to be rolled before settlement to ensure that delivery does not take place. The roll takes place periodically such that there are up to two contracts per commodity that can contribute to strategy returns during the month: the prompt (nearby) and the prompt+1 (next nearby) contract into which the prompt contract rolls (see Table 2 below).

In an embodiment, the roll schedule for soybean oil and rapeseed is the 5th business day through the 9th of each month during which the contract is scheduled to roll and for palm oil it is the 1st business day through the 5th of each month during which the contract is scheduled to roll. Taking soybean oil or rapeseed as an example, the roll period will begin on the 5th business day and will last for five business days. On the 5th business day of a roll month, commodity returns will reflect 100% of the price movements of the prompt contract. At the end of the 5th business day, 20% of the prompt contract will be rolled to the prompt+1 contract. At the beginning of the 6th business day, commodity returns will reflect a contract basket containing 80% of the prompt contract and 20% of the prompt+1 contract. At the end of the day, an additional 20% will be rolled. This process will continue until the beginning of the 9th business day when 100% of the commodity pricing will be coming from the prompt+1 contract. Palm oil will act in the same way although the final roll will be on the 5th business day.

TABLE 2
Roll Calendar for Each Biodiesel Commodity Futures Contract

Commodity

| | | |
|---|---|---|
| Rapeseed | Palm Oil | Soybean Oil |

Exchange

| | | |
|---|---|---|
| Euronext/Liffe | MDEX | CBOT |

Ticker:

| Month | ECO | PO | BO |
|---|---|---|---|
| Jan (F) | K | H/J | H |
| Feb (G) | K | J/K | H/K |
| Mar (H) | K/Q | K/M | K |
| Apr (J) | Q | M/N | K/N |
| May (K) | Q | N/Q | N |
| June (M) | Q/X | Q/U | N/Z |
| July (N) | X | U/V | Z |
| Aug (Q) | X | V/X | Z |
| Sep (U) | X/G | X/Z | Z |
| Oct (V) | G | Z/F | Z/F |
| Nov (X) | G | G/H | F |
| Dec (Z) | G/K | G/H | F/H |

The invention further comprises products based on the embodiments described above. Three exemplary products (Delta One Certificates, Booster Notes, and Buffered Notes) are described below in Tables 3 and 4, and one such product is described in further detail in the Appendix below.

TABLE 3
Biodiesel Strategy Products: Exemplary Terms and Conditions

| Delta One Certificate | | Booster Note | |
|---|---|---|---|
| Issuer | Issuer | Issuer | Issuer |
| Investment | 5 years | Investment | 5 years |
| Horizon | | Horizon | |
| Base | USD | Base | USD |
| Currency | | Currency | |
| Risk | No Capital Protection | Risk | No Capital Protection |
| Cash Flows | Payment at Redemption | Cash Flows | Payment at Redemption |
| Underlyings | Biodiesel Strategy | Underlyings | Biodiesel Strategy |
| | | Vol Cap | The performance of the |
| | | | Strategy is subject to |
| | | | volatility protection |
| | | | (volcap) of 22% |
| Redemption | At maturity the Delta | Redemption | At maturity, the investor |
| | One Certificate will | | will receive: 200% of the |
| | pay the performance of | | positive performance of |
| | the Strategy - 65 bps/ | | the strategy and 100% of |
| | annum. | | the negative performance |

TABLE 4
Biodiesel Strategy Products: Exemplary Terms and Conditions
Buffered Note

| Issuer | Issuer |
|---|---|
| Investment Horizon | 5 years |
| Base Currency | USD |
| Risk | Partial Capital Protection |
| Cash Flows | Payment at Redemption |
| Underlyings | Biodiesel Strategy |
| Vol Cap | The performance of the Strategy is subject to |
| | volatility protection (volcap) of 22% |
| Redemption | At maturity, the investor will receive: 140% of |
| | the positive performance of the strategy and |
| | 100% of the negative performance of the note |
| | below 90% |

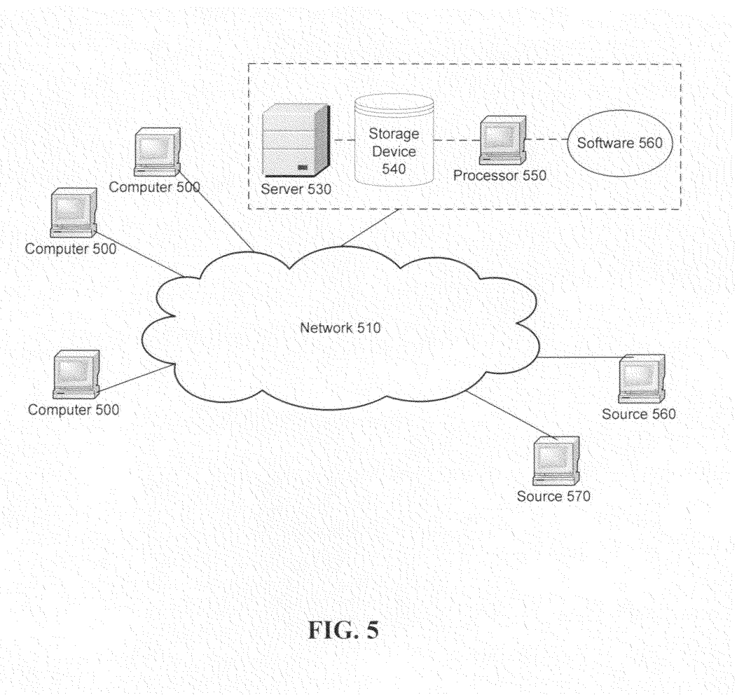

Embodiments of the present invention comprise computer components and computer-implemented steps that will be apparent to those skilled in the art. For example, calculations and communications can be performed electronically. An exemplary system is depicted in FIG. 5. As shown, computers 500 communicate via network 510 with a central server 530. A plurality of sources of data 560, 570 relating to, for example, commodities futures data, also communicate via network 510 with a central server 530, processor 550, and/or other component to calculate and transmit, for example, weighting data. The server 530 may be coupled to one or more storage devices 540, one or more processors 550, and software 560.

Other components and combinations of components may also be used to support processing data or other calculations described herein as will be evident to those skilled in the art. Server 530 may facilitate communication of data from a storage device 540 to and from processor 550, and communications to computers 500. Processor 550 may optionally include local or networked storage (not shown) which may be used to store temporary information. Software 560 can be installed locally at a computer 500, processor 550 and/or centrally supported for facilitating calculations and applications.

For ease of exposition, not every step or element of the present invention is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the present invention.

Embodiments of the present invention may be applied in contexts beyond those specifically described, for example, generally, indices with components denominated in more than one currency, and commodities, strategies, or other commercial endeavor in which historical data or objective data are unavailable or which may be considered non-indicative of present or future performance.

Appendix-Exemplary Terms of 1 Year Linked Notes Linked
to Biodiesel Strategy

| | |
|---|---|
| Issuer | Issuer |
| ISIN | TBD |
| Nominal | TBD |
| Amount | |
| Trade Date | TBD |
| Strike Date | TBD |
| Issue Date | TBD |
| Valuation Date | TBD |
| Maturity Date | TBD |
| Issue Price | 100.00% |
| Strategy | Global Bio-diesel Excess Return |
| Strategy | Strategy Sponsor |
| Sponsor | |
| Redemption | Nominal Amount × (Strategy Performance + Adjustment |
| Price | Percentage) |
| | Closing Strategy Level means, in respect of a Strategy |
| | and any day, the official closing level of such Strategy on |
| | such day, as published by the Strategy Sponsor at or |
| | about the Valuation Time on such day, or as otherwise |
| | determined by the Calculation Agent in its sole and |
| | absolute discretion. |
| | Final Strategy Level means the Closing Strategy Level on |
| | the Valuation Date, as determined by the Calculation |
| | Agent. |
| | Initial Strategy Level means, [•], being the Closing |
| | Strategy Level on the Strike Date, as determined by the |
| | Calculation Agent. |
| | Valuation Time means, in respect of a Strategy, the time |
| | at which the official closing level of the Strategy is |
| | calculated and published by the Strategy Sponsor. |
| | $Strategy Performance = \frac{FinalIndexLevel}{InitialIndexLevel}$ |
| | Adjustment Percentage: [TBD] |
| Participation | 100% |
| Principal | 0% |
| Protection | The Notes are not principal protected. The Redemption |
| | Price may be less than the original purchase price paid |
| | for the Notes and in certain circumstances may be zero. |
| Coupon Rate | No coupons shall be paid |
| Coupon | Not Applicable |
| Payment Dates | |
| Day Count | Not applicable |
| Fraction | |
| Business Days | London and New York |
| Business Day | Following Business Day Convention |
| Convention | |
| Disruption | Strategy Valuation Date Disruption Events and Fallbacks: |
| Events and | Applicable |
| Fallbacks | “Strategy Valuation Date Disruption Events” are events |
| | that would give rise, in accordance with the applicable |
| | Strategy Valuation Date Fallbacks, to an alternative basis |
| | for determining the relevant level of a Strategy were the |
| | event to occur or exist on any day. The following events |
| | are Strategy Valuation Date Disruption Events: |
| | (i) Market Disruption Events and (ii) Strategy |
| | Unavailability Event each as described in the Final |
| | Terms. |
| | “Strategy Valuation Date Fallbacks” are (i) Post- |
| | ponement (for up to eight consecutive Trading Days) |
| | followed by (ii) Calculation Agent Determination, each |
| | as described in the Final Terms. |
| Calculation | Calculation Agent |
| Agent | |
| Listing | None |
| Denominations | TBD |
| Issue Type | Euro Medium Term Note (EMTN) |
| Secondary | Under normal market conditions, Calculation Agent will |
| Market | make a daily secondary market in the Notes on a daily |
| | basis with a bid-ask spread no larger than 1%. |
| Selling | As per EMTN programme. |
| Restrictions | European Prospectus Directive Selling Restriction: The |
| | Notes described in this termsheet are the subject, for the |
| | purposes of Article 5.4 of the Prospectus Directive |
| | (Directive 2003/71/BC), of the Issuer's Base Prospectus |
| | as supplemented from time to time (the “Base |
| | Prospectus”), which constitutes a base prospectus for the |
| | purposes of the Prospectus Directive, and are the subject |
| | also of Final Terms dated on or before the Issue Date. |
| | The Base Prospectus has been approved by the competent |
| | authority for Ireland, which has been requested to |
| | provide the competent authority of each of Belgium, |
| | Germany, Luxembourg, the Netherlands, Portugal, Spain, |
| | Austria, Greece, France, Czech Republic, Hungary, Italy, |
| | Poland, Slovakia, Sweden and the United Kingdom with |
| | a certificate of approval attesting that the Base Prospectus |
| | has been drawn up in accordance with the Prospectus |
| | Directive (each such jurisdiction, including Ireland, a |
| | “Passported State”). Your attention is drawn, however, |
| | to the fact that Passported States may have further local |
| | law requirements which must be complied with prior to |
| | making a public offer of the Notes. The Base Prospectus |
| | has not been approved by or passported into any other |
| | EEA member state which has implemented the |
| | Prospectus Directive and, accordingly, Notes may only |
| | be offered in such other member states in circumstances |
| | which do not require the publication of a prospectus |
| | pursuant to Article 3 of the Prospectus Directive. All |
| | offers or sales of Notes must in any event be made only |
| | in compliance with the laws and regulations governing |
| | the same. You are strongly advised to seek appropriate |
| | legal advice before attempting to make any offer. In |
| | purchasing any Notes you represent to Lehman Brothers |
| | that you do not intend to make an offer which will breach |
| | the Prospectus Directive or any other laws or regulations, |
| | or cause Lehman Brothers or the Issuer to be in breach of |
| | the Prospectus Directive or any other laws or regulations. |
| | US Selling Restriction: The Notes have not been nor will |
| | be registered under the U.S. Securities Act of 1933 |
| | (as amended) and may not be offered or sold within the |
| | United States or to, or for the account or benefit of, |
| | U.S. persons except as permitted by Regulation S or |
| | Rule 144A under such Securities Act. General Selling |
| | Restriction: Each purchaser of Notes must observe all |
| | applicable laws and regulations in any jurisdiction in |
| | which it may offer, sell, or deliver the Notes and it may |
| | not, directly or indirectly, offer, sell, resell, reoffer or |
| | deliver any Notes except under circumstances that will |
| | result in compliance with all applicable laws and |
| | regulations |
| Risk | Prospective purchasers of Notes should conduct their |
| Disclosure | own investigations and in deciding whether or not to |
| | purchase Notes form their own views of the merits of |
| | an investment referencing one or more indices or other |
| | underlying commodities (collectively, the “reference |
| | assets”) based upon such investigations and not in |
| | reliance on any information given in these terms. |
| | An investment in the Notes is suitable only for, and |
| | should be made only by an investor who has no need for |
| | liquidity and understands and can afford the financial |
| | and other risks of the Notes. The risks of the Notes are |
| | principally those of credit exposure to the issuer and |
| | exposure to variations in the reference assets to which |
| | the coupon and/or redemption amount is linked. |
| | Any change in the price of the reference assets may result |
| | in the reduction of the amount of interest payable and/or |
| | amount payable at redemption so that in certain |
| | circumstances the Redemption Price may be less than the |
| | original purchase price paid for the Notes and in certain |
| | circumstances, may be zero. The prices of commodities, |
| | including oil, and indices of commodities may be |
| | volatile, and, for example, may fluctuate substantially |
| | if natural disasters or catastrophes, such as hurricanes, |
| | fires or earthquakes, affect the supply or production of |
| | such commodities. |

Commodity Definitions

All capitalized terms used herein and not otherwise defined have the meanings provided below.

“Strategy Component” means each commodities or futures contract included in a Strategy;

“Required Date” means any date on which a level for the Strategy is required in order to make any calculation, observation or determination hereunder;

“Relevant Exchange” means, in respect of a Strategy, any organized exchange or market of trading for any Strategy Component then included such Strategy;

“Trading Day” means, in respect of a Strategy Component, a day as determined by the Calculation Agent, on which trading is generally conducted on the Relevant Exchange applicable to such Strategy Component;

“Valid Business Day” means a day as determined by the Calculation Agent, on which trading is generally conducted on the Relevant Exchange for each and every Strategy Component then comprising such Strategy;

1. Market Disruption Events

“Market Disruption Event” means, in respect of any relevant day and a Strategy (and a Market Disruption Event shall be deemed to have occurred on such day and such Strategy if), in the determination of the Calculation Agent in good faith, one or more of the following has occurred on such day:

(a) The Strategy is not calculated and published by the relevant Strategy Sponsor (provided that the Calculation Agent may, if the Market Disruption Event in this paragraph (a) also constitutes a Strategy Disruption Event (defined below), or occurs on the same day as a Strategy Disruption Event, in its sole discretion, determine that the provisions relating to the occurrence of a Strategy Disruption Event take precedence over the provisions relating to the occurrence of a Market Disruption Event);

(b) There is a material suspension, limitation or disruption in the trading on a Relevant Exchange of any Strategy Component;

(c) The settlement price on a Relevant Exchange of any Strategy Component has increased or decreased by an amount equal to the maximum permitted price change from the previous day's settlement price as specified by the Relevant Exchange; or

(d) The settlement price of any Strategy Component is not published by the Relevant Exchange.

Notwithstanding the foregoing, the following events will not constitute Market Disruption Events:

(i) a limitation on the hours in a Trading Day and/or number of Trading Days, if it results from an announced change in the regular business hours of the Relevant Exchange; or

(ii) a decision to permanently discontinue trading in a Strategy Component then included in such Strategy.

2. Disruption Fallbacks

If, in respect of a Strategy, the Calculation Agent determines that a Market Disruption Event has occurred or exists in relation to any Strategy Component on a day that is a Required Date (each such Strategy Component, an “Affected Strategy Component” and any such date, a “Disrupted Date”) the Calculation Agent will determine any required level of the Strategy in good faith in accordance with the formula for and method of calculating the Strategy last in effect prior to the commencement of the Market Disruption Event using:

(a) in relation to each Strategy Component which is not an Affected Strategy Component, the settlement price on the applicable Relevant Exchange of each such Strategy Component on the Disrupted Date; and

(b) in relation to each Affected Strategy Component, the settlement price of the Affected Strategy Component on the applicable Relevant Exchange on the first succeeding Trading Day on which no Market Disruption Event is in existence, provided that, where the relevant Market Disruption Event has been in existence (measured from and including the first Disrupted Date) for 5 consecutive Trading Days, the settlement price of such Affected Strategy Component on such Disrupted Date will be the Calculation Agent's good faith estimate of the value of such Affected Strategy Component on such Trading Day taking into consideration the latest available quotation for the relevant Strategy Component and any other information in good faith it deems relevant.

3. Successor Strategy

If, on any Required Date, an Strategy is (i) not calculated and announced by the Strategy Sponsor but is calculated and announced by a successor sponsor acceptable to the Calculation Agent, or (ii) replaced by a successor strategy using, in the determination of the Calculation Agent, the same or a substantially similar formula for and method of calculation as used in the calculation of that Strategy, then in each case that strategy (the “Successor Strategy”) will be deemed to be a Strategy for the purposes of the Notes provided, however, that the Calculation Agent, in its sole discretion, may make such adjustments as it deems necessary to the level of the Successor Strategy so that the level of the Successor Strategy reflects the same level as that of the Strategy before it was replaced.

4. Strategy Disruption Event

If, (i) on or prior to any Required Date, a Strategy Sponsor announces that it will make a material change in the formula for or the method of calculating a Strategy or in any other way materially modifies a Strategy (a “Strategy Modification”) or permanently cancels a Strategy and no Successor Strategy exists (a “Strategy Cancellation” and together with a Strategy Modification, each a “Strategy Disruption Event”), then the Calculation Agent shall determine the required level for such Strategy in its sole discretion, in accordance with the formula for and method of calculating that Strategy last in effect prior to the change, failure or cancellation, but using only the settlement prices of those Strategy Components that comprised that Strategy immediately prior to that Strategy Disruption Event (or if trading in the relevant Strategy Components has been materially suspended or limited, its good faith estimate of the settlement price for such Strategy Components that would have prevailed but for such suspension or limitation on such Required Date).

5. Correction of Strategy Levels

In the event that any level of a Strategy published by the relevant Strategy Sponsor and which is utilized for any calculation or determination in respect of the Notes on any relevant date is subsequently corrected and the correction is published by the Strategy Sponsor on or before the day falling 30 days following such publication (the “Correction Cut-off Date”) in respect of such date, the Calculation Agent will notify the Issuer and the Noteholders in accordance with the Terms and Conditions of the Notes of (i) that correction, (ii) the amount that is payable as a result of that correction and (iii) take such other action as it may deem necessary to give effect to such correction.

“Correction Cut-off Date” means, in respect of any Required Date, the date immediately following such Required Date.

6. Manifest Error in Publication:

If, on any Required Date the Calculation Agent, acting in good faith and in a commercially reasonable manner, determines that a Strategy Sponsor has made a manifest and material error in its calculation of a Strategy and the relevant Strategy Sponsor fails to remedy such error before the Correction Cut-off Date, the Calculation Agent will:

(a) in lieu of a published level for that Strategy, use its good faith estimate of the required level of the Strategy determined in accordance with the formula for and method of calculating that Strategy last in effect as of the Valid Business Day which immediately preceded such Required Date; and

(b) notify the Fiscal Agent and the Noteholders in accordance with the Terms and Conditions of the Notes of (i) that revision, (ii) the amount that is payable as a result of that revision and (iii) take such other action as it may deem necessary to give effect to such revision.

7. Adjustment to Required Dates:

If any Required Date falls on a day which is not a Valid Business Day, such Required Date shall be the next following Valid Business Day.

What is claimed is:

1. A computer-implemented method comprising:
electronically receiving data regarding projections of commodity consumption for exchange-traded futures contracts on one or more biofuel feedstock commodities;
selecting, based on said received data, one or more of said futures contracts for inclusion in a biofuel excess return strategy index; and
electronically weighting each of said selected one or more futures contracts;
wherein said weighting is based on projected relative consumption of each commodity corresponding to said selected futures contracts.

2. A method as in claim 1, wherein said projected relative consumption is based on one or more projections for consumption of each commodity over a future period of time.

3. A method as in claim 2, wherein at least one of said projections is made by a non-trading desk entity.

4. A method as in claim 1, wherein no commodity is weighted more than a specified maximum weight.

5. A method as in claim 1, wherein no commodity is weighted less than a specified minimum weight.

6. A method as in claim 1, wherein said biofuel is biodiesel.

7. A computer-implemented method comprising:
electronically receiving data regarding prices of one or more exchange-traded futures contracts;
selecting, based on said received data, one or more of said futures contracts for inclusion in a commodity index; and
electronically calculating excess return for each of said commodities by accounting for foreign exchange rates.

8. A method as in claim 7, wherein excess return of a commodity comprises daily price appreciation of associated futures contracts of said commodity plus roll yield.

9. A method as in claim 7, wherein daily excess return of a commodity is calculated based on a first product comprising a commodity futures contract price for a first day multiplied by a difference between a spot currency exchange rate for said first day and a spot next currency swap rate for a day immediately preceding said first day.

10. A method as in claim 9, wherein daily excess return of a commodity is calculated further based on dividing said first product by a second product comprising a commodity futures contract price for said day immediately preceding said first day multiplied by a spot currency exchange rate for said day immediately preceding said first day.

11. A method as in claim 7, wherein daily excess return is based on a product of a commodity futures contract price and a foreign exchange rate, and wherein said foreign exchange rate is corrected for overnight drift.

12. A method as in claim 7, wherein foreign exchange spot rates are used in calculation of excess return, and said calculation is adjusted to take into account an overnight funding differential between two currencies.

13. A method as in claim 12, wherein said differential is calculated on a weekly basis.

14. A method as in claim 12, further comprising receiving one or more valuations for spot week forward transactions and calculating a daily differential for a subsequent week.

15. A computer system comprising:
a database component configured to electronically receive and store data regarding projections of commodity consumption for exchange-traded futures contracts on one or more biofuel feedstock commodities;
a selection component configured to select, based on said received and stored data, one or more of said futures contracts for inclusion in a biofuel excess return strategy index; and
a weighting component configured to electronically weight each of said selected one or more futures contracts;
wherein said weight is based on projected relative consumption of each commodity corresponding to said selected futures contracts.

16. A computer system as in claim 15, wherein said projected relative consumption is based on one or more projections for consumption of each commodity over a future period of time.

17. A computer system as in claim 16, wherein at least one of said projections is made by a non-trading desk entity.

18. A computer system as in claim 15, wherein no commodity is weighted more than a specified maximum weight.

19. A computer system as in claim 15, wherein no commodity is weighted less than a specified minimum weight.

20. A computer system as in claim 15, wherein said biofuel is biodiesel.

21. A computer system comprising:
a database component configured to electronically receive and store data regarding prices of one or more exchange-traded futures contracts;
a selection component configured to select, based on said received and stored data, one or more of said futures contracts for inclusion in a commodity index; and
a calculation component configured to electronically calculate excess return for each of said commodities by accounting for foreign exchange rates.

22. A computer system as in claim 21, wherein excess return of a commodity comprises daily price appreciation of associated futures contracts of said commodity plus roll yield.

23. A computer system as in claim 21, wherein daily excess return of a commodity is calculated based on a first product comprising a commodity futures contract price for a first day multiplied by a difference between a spot currency exchange rate for said first day and a spot next currency swap rate for a day immediately preceding said first day.

24. A computer system as in claim 23, wherein daily excess return of a commodity is calculated further based on dividing said first product by a second product comprising a commodity futures contract price for said day immediately preceding said first day multiplied by a spot currency exchange rate for said day immediately preceding said first day.

25. A computer system as in claim 21, wherein daily excess return is based on a product of a commodity futures contract price and a foreign exchange rate, and wherein said foreign exchange rate is corrected for overnight drift.

26. A computer system as in claim 21, wherein foreign exchange spot rates are used in calculation of excess return, and said calculation is adjusted to take into account an overnight funding differential between two currencies.

27. A computer system as in claim 26, wherein said differential is calculated on a weekly basis.

28. A computer system as in claim 26, further comprising a valuation component configured to receive one or more valuations for spot week forward transactions and calculating a daily differential for a subsequent week.

29. Software stored in a computer readable medium, said software comprising:
software for electronically receiving data regarding projections of commodity consumption for exchange-traded futures contracts on one or more biofuel feedstock commodities;
software for selecting, based on said received data, one or more of said futures contracts for inclusion in a biofuel excess return strategy index; and
software for electronically weighting each of said selected one or more futures contracts;
wherein said weighting is based on projected relative consumption of each commodity corresponding to said selected futures contracts.

30. Software as in claim 29, wherein said projected relative consumption is based on one or more projections for consumption of each commodity over a future period of time.

31. Software as in claim 30, wherein at least one of said projections is made by a non-trading desk entity.

32. Software as in claim 29, wherein no commodity is weighted more than a specified maximum weight.

33. Software as in claim 29, wherein no commodity is weighted less than a specified minimum weight.

34. Software as in claim 29, wherein said biofuel is biodiesel.

35. Software stored in a computer readable medium, said software comprising:
software for electronically receiving data regarding prices of one or more exchange-traded futures contracts;
software for selecting, based on said received data, one or more of said futures contracts for inclusion in a commodity index; and
software for electronically calculating excess return for each of said commodities by accounting for foreign exchange rates.

36. Software as in claim 35, wherein excess return of a commodity comprises daily price appreciation of associated futures contracts of said commodity plus roll yield.

37. Software as in claim 35, wherein daily excess return of a commodity is calculated based on a first product comprising a commodity futures contract price for a first day multiplied by a difference between a spot currency exchange rate for said first day and a spot next currency swap rate for a day immediately preceding said first day.

38. Software as in claim 37, wherein daily excess return of a commodity is calculated further based on dividing said first product by a second product comprising a commodity futures contract price for said day immediately preceding said first day multiplied by a spot currency exchange rate for said day immediately preceding said first day.

39. Software as in claim 35, wherein daily excess return is based on a product of a commodity futures contract price and a foreign exchange rate, and wherein said foreign exchange rate is corrected for overnight drift.

40. Software as in claim 35, wherein foreign exchange spot rates are used in calculation of excess return, and said calculation is adjusted to take into account an overnight funding differential between two currencies.

41. Software as in claim 40, wherein said differential is calculated on a weekly basis.

42. Software as in claim 40, further comprising software for receiving one or more valuations for spot week forward transactions and calculating a daily differential for a subsequent week.
